(19) United States
(12) Patent Application Publication
(10) Pub. No.: US 2002/0169272 A1
(43) Pub. Date: Nov. 14, 2002

(54) Polyfunctional urethane-or urea-containing oligomers for use in polymer preparation

(76) Inventors: Leonid Rappoport, Mountain View, CA (US); Alex Vainer, Fremont, CA (US); Aleksander Yam, Sunnyvale, CA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/102,517

(22) Filed: Mar. 19, 2002

Related U.S. Application Data
(63) Continuation-in-part of application No. 09/277,802, filed on Mar. 27, 1999, now Pat. No. 6,369,188.
(60) Provisional application No. 60/079,692, filed on Mar. 27, 1998.

(51) Int. Cl. C08G 18/08

(52) U.S. Cl. 528/49

(57) ABSTRACT

Polyfunctional polymerizable urethane- or urea-containing oligomers allow the design, adjustment, and regulation of chemical and physical properties of the described oligomers. The invention discloses the formulas and compositions of these oligomers and methods of their synthesis. The described oligomers can be used for many purposes, both directly and in combination with other chemicals in multiple applications such as adhesives, sealants, coatings, composites, etc., as well as in castable and moldable materials.

### CROSS-REFERENCE TO RELATED APPLICATIONS

This application is a continuation-in-part of copending patent application Ser. No. 09/277,802, filed on Mar. 27, 1999, which is herein incorporated by reference in its entirety. This application claims priority of provisional application No. 60/079,692, filed on Mar. 27, 1998, which is herein incorporated by reference in its entirety.

### FIELD OF THE INVENTION

This invention relates generally to compounds for polymerization and formation thereof, and particularly to urethane- and urea-containing oligomers having two or more functional groups.

### BACKGROUND OF THE INVENTION

Various classes of polymers are used in everyday life as adhesives, sealants, coatings as well as cast able and moldable materials. The class of a polymer reflects the structure of chemical links incorporated into the polymer. These links are formed through the interaction of functional groups of oligomers and monomers, and are responsible for the macroscopic properties exhibited by the polymer.

Polyurethanes, currently being used in the plastics, paint, and adhesives industries, are one of the classes of polymers with the most attractive combination of properties. They combine the qualities of: strength in the non-filled state; very high chemical resistance; excellent impact, scratch and abrasion resistance; toughness; excellent adhesion to most substrates; and, in many cases, very good flexibility.

Most of the other classes of polymers could be significantly improved by the introduction of the urethane links into the polymer.

The intention to combine the advantages of polyurethane with the inherent properties of other resins has led to the synthesis of urethane-epoxies as described in, for example, Russian Patent No. 287,589 and U.S. Pat. Nos. 2,830,038, 3,984,376, 4,520,185, and 5,484,853; urethane-acrylics and urethane-methacrylics as described in, for example, in U.S. Pat. Nos. 3,850,770, 4,131,600, 4,133,723, 4,153,778, 4,246,391, 4,330,657, 4,339,566, 4,507,458, 4,587,201, 4,605,723, 5,006,436, and 5,616,630; urethane-alkoxysilanes as described in, for example, U.S. Pat. Nos. 4,374,237; 4,555,561; and 4,857,623; and urethane-vinyls and allyls, as described in, for example, U.S. Pat. Nos. 3,719,638, 4,119,510, and 5,580,947. The increased degree of cross-linking, together with the introduction of multiple urethane groups into conventional polymers, greatly improves their stability to abrasive-scratch action, resistance to solvents, flexibility, toughness, impact and thermal shock resistance, and adhesive properties, without causing changes in application technology. However, in the literature there are only a small number of references to functional groups being combined with urethanes in single oligomeric molecules, and they are limited to the aforementioned compounds. Despite the obvious advantages of the described products, they are not widely used in the industrial applications. The limited amount of the utilized functional groups, difficulty in the adjustment of physical and chemical properties of products, and complex and limited methods of producing compounds described in available literature, has lead to limitations on the range of properties of both produced oligomers and the final products obtained after their curing.

### BRIEF SUMMARY OF THE INVENTION

It is an object of this present invention to provide novel oligomeric materials as precursors to polymers, the oligomeric materials having advantages over other known oligomers. It is a specific object of the present invention to provide inventive polyfunctional urethane- or urea-containing oligomers. It is a further object of the invention to provide methods of synthesis of the oligomeric materials.

In a first aspect, this invention provides oligomers of formula

B(A)ₙ

where

B is a backbone,

A is a formula —R—C(O)—R₂—R₃, and

n is an integer of at least 2, said integer defining the number of said A's bonded to said B, wherein

said B is selected from the group consisting of polyesters, polyethers, polyolefins, polybutadienes, polysiloxanes, polycarbonates, carbohydrates, polyacrylates, polysulfides and mixtures and copolymers thereof;

each R₁, which may be same or different between said A's, is selected from the group consisting of —O—, —S—,

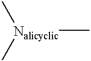

where the nitrogen atom N_{alicyclic} is heterocyclic, or —(R₅)—where R₅ is selected from the group consisting of hydrogen and a monovalent organic radical;

C(O) is a carbonyl;

each R₂, which may be same or different between said A's, is a bivalent organic radical; and

each R₃ is an isocyanate group of formula —═C═O or a group of formula —C(O)—R₁′—R₄—ƒ, wherein

at least two different R₃ groups are always present in said oligomer and if one of said R₃ groups is isocyanate, then at least three different R₃ groups are present in said oligomer;

each R₁′, which may be same or different from R₁ within each of said A's, is defined the same as R₁;

each R₄ is a radical selected from the group consisting of bivalent aliphatic, bivalent cycloaliphatic, bivalent aromatic, bivalent substituted aliphatic, bivalent substituted cycloaliphatic, bivalent substituted aromatic radicals, bifunctional polyesters, bifunctional polyethers, bifunctional polyolefins, bifunctional polybutadienes, bifunctional polysiloxanes, and bifunctional polyacrylates; and

each functional group ƒ is independently selected from a reactive functional group category, a catalytic and stabilizer functional group category, or a physical property-modifying functional group category.

According to principles of the present invention, the oligomer contains combinations of two of more types of functional groups ƒ, each of which either

(1) provides the means of the further polymerization of the oligomer;

(2) influences the rate of reactions that the oligomer participates in unpolymerized or polymerized form; or

(3) influences the physical properties of unpolymerized or polymerized oligomer.

In a second aspect, this invention provides methods of one- and two-stage syntheses of the aforementioned oligomers. The single stage synthesis comprises the reaction of a backbone carrier, a diisocyanate having two isocyanate groups of unequal reactivity, and at least two different functional group (FG) carriers. The two stage synthesis comprises preparation of at least two different monoisocyanate-functional reactive intermediates (MIFRIs) followed by their reaction with a backbone carrier; or alternatively, preparation of an isocyanate-terminated prepolymer, followed by its reaction with at least two different functional group (FG) carriers.

In a third aspect of the invention, the oligomers described herein can be mixed with other oligomers, the latter being an oligomer described herein or other known oligomer, to create a desired resin for eventual polymerization.

In a fourth aspect, this invention provides oligomers that can react with monomer or other oligomers to form polymers.

In a fifth aspect, this invention provides compositions such as adhesives, sealants, coatings, and composites containing these oligomers and polymers prepared therefrom.

### DETAILED DESCRIPTION OF THE INVENTION

Patents containing urethane- or urea-containing oligomers with more than one functional group are few. For teachings on urethane-alkoxysilane-alkyl, readers are directed to U.S. Pat. No. 4,857,623, entitled “Alkoxysilane-Terminated, Moisture-Hardening Polyurethanes and their use in Adhesives and Sealing Compositions,” issued to W. Emmerling and T. Podola, and assigned to Henkel Kommanditgesellschaft auf Aktien of Germany. For urethane-aminoalkoxysilane-stearyl alcohol, readers are directed to U.S. Pat. No. 6,121,354, entitled “High Performance Single Component Sealant” issued to M. Chronister, and assigned to Bostik, Inc of U.S.A. Both patents are herein incorporated by reference.

In addition, U.S. Pat. No. 4,224,454 entitled “Photoinitiation Systems for Free Radical Polymerization Reactions” issued to J. R. McDowell et al., assigned to Lord Corporation, discloses acyloin urethane photoinitiation molecules that contain no polymer backbone. The teachings of that patent are herein incorporated by reference.

### Structure

The present invention provides inventive “polyfunctional reactive urethane- or urea-containing oligomers” (PRUOs). PRUOs are “polyfunctional”, that is, they contain more than one type of functional group, and consequently are compounds that have multiple, diverse, and useful properties. These properties are determined by the type, functionality and length of the backbone, the type of linkages (urethane or substituted urea), and the types, combinations and relative amounts of functional groups on the PRUO. The PRUO is a compound of the formula:

B(A)ₙ

where

B is a backbone,

A is a formula —R₁′,(O)—NH—R₂—R₃, and

n is an integer of at least 2, said integer defining the number of said A's bonded to said B, wherein

said B is selected from the group consisting of polyesters, polyethers, polyolefins, polybutadienes, polysiloxanes, polycarbonates, carbohydrates, polyacrylates, polysulfides and mixtures and copolymers thereof;

each R₁, which may be same or different between said A's, is selected from the group consisting of —O—, —S—,

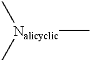

where the nitrogen atom Nalicyclic is heterocyclic, or —N(R₅)— where R₅ is selected from the group consisting of hydrogen and a monovalent organic radical;

C(O) is a carbonyl;

each R₂, which may be same or different between said A's, is a bivalent organic radical; and

each R₃ is an isocyanate group of formula —N═C═O or a group of formula —NH—C(O)—R₁′—R₄—ƒ, wherein

at least two different R₃ groups are always present in said oligomer and if one of said R₃ groups is isocyanate, then at least three different R₃ groups are present in said oligomer;

each R₁′, which may be same or different from R₁ within each of said A's, is defined the same as R₁;

each R₄ is a radical selected from the group consisting of bivalent aliphatic, bivalent cycloaliphatic, bivalent aromatic, bivalent substituted aliphatic, bivalent substituted cycloaliphatic, bivalent substituted aromatic radicals, bifunctional polyesters, bifunctional polyethers, bifunctional polyolefins, bifunctional polybutadienes, bifunctional polysiloxanes, and bifunctional polyacrylates; and

each functional group ƒ is independently selected from a reactive functional group category, a catalytic and stabilizer functional group category, or a physical property-modifying functional group category.

The syntheses of the PRUOs described herein arise from a combination of a “backbone carrier,” a diisocyanate derivative, and a “functional group carrier”, outlined below.

A “backbone carrier” is an oligomer of formula

B(R₁H)ₙ

where B, R₁, and n are as defined previously. For clarity, note that the number n coincides with the number of A groups (defined previously) bonded to B. Additional substituents that are attached to the backbone B, can of course, for simplicity, be incorporated into the backbone “B” for nomenclature purposes. For example, a backbone B can be a polyether, a polyether with some grafted non-reactive groups groups, and similarly, a backbone B can designate a polyether with —OH groups, therefore in this latter case the oligomer can have some —OH residues designated as —R₁H, and some not. The limitation is therefore that there need be (at least) n number of —R₁H groups. It must be noted that in the case where R₁ is heterocyclic nitrogen

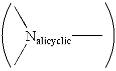

there are two single bonds to the backbone B, as opposed to the case where R₁ is —O—, —S—, or —N(R₅)—wherein there is only one single bond to the backbone.

A “functional group” (FG), ƒ, is a chemical residue that generally falls into one of three categories:

(1) a group capable of reaction by polymerization or polycondensation (reactive); or

(2) a group capable of influencing the rate of reactions (catalytic, initiating, stabilizing, etc.)

(3) a group that provides desired changes in the physical and/or chemical properties of the oligomers and products of their polymerization.

A “functional group carrier” (FG carrier) is a molecule that is used as a starting material in order to synthesize an oligomer containing a FG desired; it itself contains the FG to be incorporated into the oligomer. The FG carrier, is a compound of formula

ƒ-R₄—R_{1′}H

where ƒ, R₁′, and R₄ are as defined previously. Note that when R_{1′} is heterocyclic nitrogen

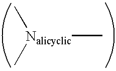

there are two single bonds to the group R₄.

The examples of some typical FGs and their carriers are shown in Table 1.

TABLE 1
Typical functional groups and carriers.

| Typical Functional Groups | |
|---|---|
| (FG) | Typical FG Carrier |
| Epoxy | Glycidol |
| 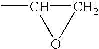 | 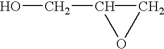 |
| Acrylic | Hydroxypropyl-acrylate |
| 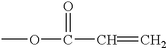 | 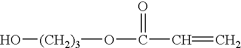 |
| Methacrylic | Hydroxyethyl-methacrylate (HEMA) |
| 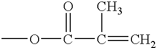 | 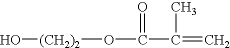 |
| Tri(alkoxy)silane | 4-Amino-tetramethylene-tri(ethoxy)silane |
| 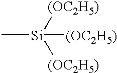 | 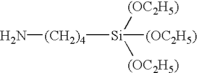 |
| Cyclocarbonate | Glycerol Carbonate |
| 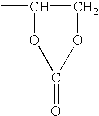 | 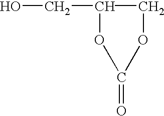 |
| Tertiary Amine | N,N′-dimethyl-ethanolamine |
| 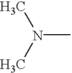 | 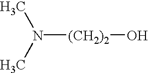 |
| Vinyloxy | Ethylene Glycol Monovinyl Ether |
| —O—CH═CH₂ | HO—(CH₂)₂—O—CH═CH₂ |
| Allyl | Ethylene Glycol Monoallyl Ether |
| —O—CH₂—CH═CH₂ | HO—(CH₂)₂—O—CH₂—CH═CH₂ |
| Mercapto | Thioglycol |
| —SH | HO—(CH₂)₂—SH |
| Ester | Hydroxy-acetic Acid Ethyl Ester |
| 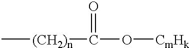 | 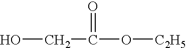 |

| | | |
|---|---|---|
| Inert Organic Radical | Alcohol | Amine |
| —CₙHₘ | HO—CₙHₘ | H₂N—CₙHₘ |

Suitable functional groups ƒ as described in this invention are selected from categories of types of functional groups including, but not limited to, a category of reactive FGs; a category of catalytic and stabilizer FGs (wherein initiators and photoinitiators are a subset of those that are catalytic); and a category of physical property modifying FGs. The reactive FGs are those that will eventually take part in polymerization. The catalytic and stabilizer functional groups are those that promote desirable reactions and slow undesirable reactions, either in the synthesis of the oligomer, or in the eventual synthesis of the polymer. The physical-property modifying functional groups are those that modify the properties (for example, viscosity, the ability to crystallize, compatibility with other substances, etc.) of the oligomers and polymers they are incorporated into but they do not have a role in the reactions themselves.

Reactive functional groups include, but are not limited to epoxy (oxirane), acrylate, methacrylate, mercaptan, vinyloxy, allyl, carboxyl, ketone, nitrile, organic nitrate, primary, secondary and tertiary amine, organic peroxide, alkoxysilane, carbonate, aromatic, saturated and unsaturated organic radicals, halogenated organic radicals, heterocyclic radicals, and the like; catalytic and stabilizer functional groups include but are not limited to, tertiary amines, imidazoles, organic peroxides, metalloorganic and heterocyclic radicals, hydroxyketones, hydroquinones, and the like; and physical property-modifying functional groups include but are not limited to aliphatic, cycloaliphatic and aromatic, saturated and unsaturated organic radicals, halogenated organic radicals, and the like.

A diisocyanate molecule is one that has two isocyanate groups with unequal reactivity of formula —N═C═O such that the diisocyanate has formula

O═C═N—R₆—N═C═O

where R₆ is either R₂ as defined previously, or has the following isocyanate dimer (uretidine dione) structure:

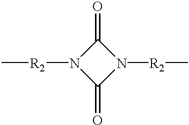

The diisocyanate is the carrier of the R₂ group to be incorporated into the PRUO.

Combination of the backbone carrier, diisocyanate, and functional group carrier leads to the formation of the oligomers of this invention (i.e. the PRUOs). Their methods of combination are the methods of synthesis of PRUOs of this invention.

It should be noted that in addition to the two or more functional groups ƒ that are incorporated into the oligomer structure, this invention teaches that there can be residual isocyanate groups intentionally incorporated into the structure (in the form of R₃). In some cases it is useful to leave this isocyanate functionality in the PRUO compound.

In the preferred embodiments, the compounds of this invention can be characterized as follows:

B is a backbone selected from polyesters (for example, poly(neopentyl glycol adipate), alkyd resins, polyethylene glycol maleate, and the like); polycarbonates; polyethers (for example, polyethylene glycol (polyoxyethylene), polyoxypropylene, polytetramethylene glycol, and the like); polyolefins (for example, castor oil, low molecular weight polyethylenes, hydrogenated polybutadiene, and the like); polybutadienes (for example, cis- and trans-polybutadienes, acrylonitrile-polybutadiene copolymers, and the like); polysiloxanes (for example, polydimethylsiloxanes, polydiethylsiloxanes, polydiphenylsiloxanes, polyphenylmethylsiloxanes, and the like); carbohydrates (for example, dextrins, cyclodextrins, cellulose ethers, and the like); polyacrylates/polymethacrylates (for example, polyethylacrylate, polymethylmethacrylate, styrenated polyacrylics, and the like); copolymers, such as block copolymers, and mixtures of two or more of the above.

R₁ is —O—, —S—,—N(R₅)—, or heterocyclic

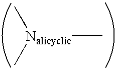

nitrogen, preferably —O—, —N(R₅)—, or heterocyclic

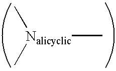

nitrogen

R₂ is the residue of a diisocyanate molecule, for example, 2,4-toluylene, 2,6-toluylene, tetramethylene, hexamethylene, trimethylhexamethylene, isophorone, and the like.

R₄ is bivalent linear or branched alkyl, aryl, polyester, or polyether, each optionally substituted with one or more non-interfering substituents, and the like.

R₅ could be hydrogen, or a monovalent (linear or branched) aliphatic, olefinic (by which is included any degree of unsaturation) or aromatic hydrocarbon radical of up to 50 carbon atoms, preferably up to 20 carbon atoms, optionally substituted with one or more non-interfering substituents.

Often, at least a portion of the functional groups ƒ are epoxy groups and/or acrylate or methacrylate groups. Strength of the present invention is that the functional groups can be varied to a great extent creating various types of oligomers with various properties. In addition to varying R₃via the selection of a different functional group or different R₄ group, the polymer formation from the oligomer may be varied by regulating the proportion of the R₃ groups that are simply isocyanate.

An examplary PRUO having a poly(oxypropylene) triol backbone, and methacrylic and epoxy FGs has the following formula:

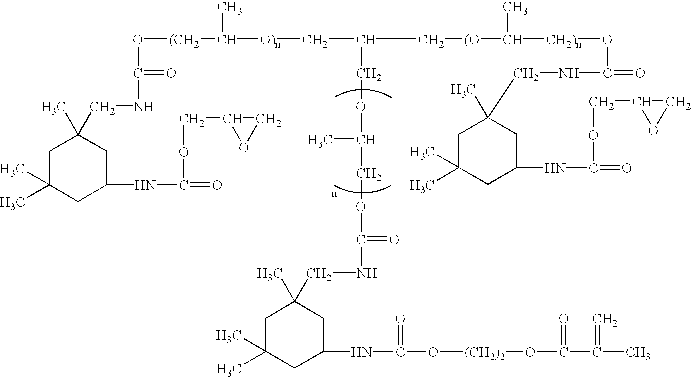

The following are some advantageous reasons to use combinations of various functional groups in one oligomeric molecule:

(1) In the case of a PRUO containing primarily acrylic groups and up to 10% of a ketone group that serves as an effective photoinitiator of radical polymerization, to increase the effectiveness of photopolymerization under the influence of visible and/or UV light, due to a reduction in the order of the catalytic reaction from second to first order (by virtue of the catalyst being part of the oligomer). The possibility of migration of the catalyst from the cure material is completely eliminated.

(2) In the case of a PRUO containing primarily acrylic groups and up to 10% of an organic peroxide group that serves as an effective catalyst of radical polymerization, to reduce the order of the catalytic reaction from second to first order, thus diminishing the necessary amount of peroxide and producing a self-curable material. The possibility of migration of the catalyst from the cured material is completely eliminated.

(3) In the case of a PRUO containing primarily epoxy groups, the addition of a noticeable (up to 40%) amount of aliphatic non-reactive FGs, such as oleyl or stearyl structures, allows a significant decrease in the viscosity of the synthesized oligomer, and increases its chemical resistance and compatibility.

(4) Both urethane-epoxies with free isocyanate functionality and epoxy-based MIFRI that utilize glycidol as the FG carrier provide a significant additional benefit, in that upon heating, they can cure without a separate hardener. Their self-curing is based on the intramolecular rearrangement of the urethane-epoxy groups that occurs upon the heating of the system to 80° C. and above with the formation of a six-membered oxazine structure

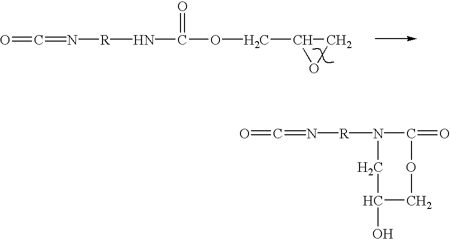

and a hydroxyl group, or with the formation of a five-membered oxazolidone structure

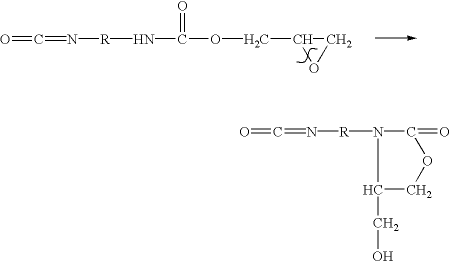

and a hydroxyl group. The ratio between the two types of heterocycles depends on the type and length of the R groups in the oligomer, however, usually 65%-70% of the oxazine and 35%-30% of the oxazolidone structures are formed.

(5) Compounds containing the urethane-epoxy and isocyanate groups can be used as very effective one-package thermally cured adhesives. The hydroxyl groups formed as the result of this intramolecular rearrangement are also reactive with free isocyanate groups that are either attached to the PRUO, or may be added to it in the form of various polyisocyanates. This mechanism provides extra cross-linking to the cured PRUO.

(6) Compounds containing epoxy and acrylic groups can be pre-cured, often favorable to the technological process under some mild conditions (such as UV radiation) with the final curing taking place under harsher conditions (such as at the high temperature). At the first stage, the action of UV light pre-cures the resin through the radical polymerization of acrylic groups, then the application of heat cures the epoxy groups, providing the necessary cross-linking. Also, the addition of a fatty-alcohol FG eliminates the excessive cross-linking and reduces the viscosity of the resin.

### Synthesis of the PRUOs in One Stage

PRUOs can be synthesized in one stage by mixing together three types of precursors:

(1) at least one backbone carrier;

(2) at least one diisocyanate having unequal reactivity of the isocyanate groups, such as, for example, isophorone diisocyanate, 2,4-toluylene diisocyanate, or trimethylhexamethylene diisocyanate; and

(3) at least two different functional group carriers.

The single stage synthesis is often used when the kinetics of the various stepwise reactions involved allow only a single type of PRUO to be formed due to unequal reactivities of the two diisocyanate ends, and also unequal reactivities of the functional group carriers.

For example, kinetics dictates the reactions of 2,4-toluylene diisocyanate (2,4 TDI),

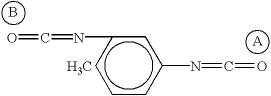

The reactivity of the isocyanate group “A” is 3-5 times higher than that of group “B”, where the reactivity of the isocyanate group is inhibited by the presence of an adjacent methyl group [J. H. Saunders, K. C. Frish, “Polyurethanes, Chemistry and Technology, Interscience Publishers, NY]. In isophorone diisocyanate (IPDI),

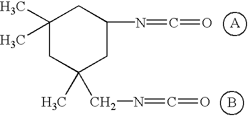

the activity of cycloaliphatic isocyanate group “A” is 10 times higher than that of the aliphatic group “B” [F. Gum, W. Riese, H. Ulrich, “Reaction Polymers: Polyurethanes, Epoxies, Unsaturated Polyesters, etc. Chemistry, Technology, Applications, Markets”, Hanser Publishers, NY].

Therefore, if IPDI or 2,4 TDI are mixed with FG carriers (molar ratio 1:1), the “A” isocyanate groups will combine with an active hydrogen-containing FG carrier (such as those listed in the Table 2) under very mild conditions, as shown below in the reaction between glycidol and 2,4 TDI. The participation of the “B” isocyanate groups with much lower reactivity is negligible.

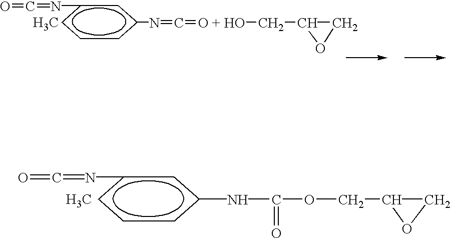

In the case when the FG carrier has active hydrogen in the hydroxyl group, the reaction leads to the formation of the urethane group. For example, the reaction of IPDI with hydroxy-ethyl-methylmethacrylate (HEMA) produces an urethane MIFRI with an isocyanate group at one end an methacrylate group at the other end of the molecule.

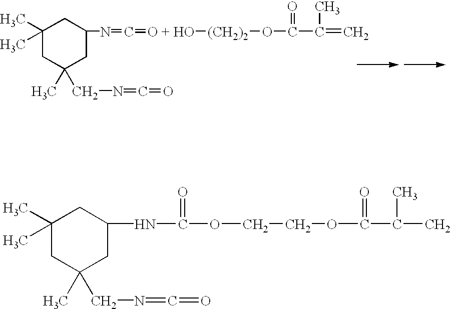

In addition, due to the similarity of the “backbone carrier”-isocyanate reaction to the “functional group carrier”-isocyanate reaction, it is preferred that the reactivity of the R₁H/R₁′H groups of the functional group carriers and backbone carriers towards the isocyanate groups of the diisocyanate used also shall be unequal (for example, one primary, another secondary, another activated by adjacent structure, etc.). This is the condition under which the one-stage synthesis is conducted; individual reactions occur sequentially depending on kinetics, thereby ensuring product integrity. Although preferred, this single stage synthesis is not limited by the necessity of having reactants of unequal reactivity, but one should expect various types of oligomers formed if reactivities of reactants are similar; this is, most often, an undesirable scenario.

Since the product oligomer depends on the number of equivalents of each of the reactants, it is often possible to design a scenario which leaves some of the isocyanate group unreacted, thereby creating, for instance, an isocyanate R₃ group; or alternatively, leaving some of the —R₁H groups on the backbone unreacted.

Residual isocyanate groups R₃groups can be made to remain on the oligomer using a single-stage synthesis method by manipulation of the stoichiometry of the reaction; for instance, where the sum of —R₁H equivalents of backbone carrier equals one-half the total amount of isocyanate equivalents of the diisocyanate, the sum of the —R₁′H equivalents of the FG carriers is less than one-half the total isocyanate functionality of the diisocyanate, and activity of —R₁′H group of the FG carrier is lower than activity of —R₁H group of the backbone carrier.

In a single stage synthesis method, manipulation of stoichiometry can allow retaining residual —R₁H groups from the backbone in the case when these groups are less reactive that the —R₁′H groups of FG carriers. In this case FG carriers are taken in such an amount that the sum of their —R₁′H equivalents equals one-half the total amount of isocyanate equivalents of the diisocyanate, and the backbone carrier is taken in such an amount that the sum of its —R₁H equivalents exceeds one-half the total amount of isocyanate equivalents of the diisocyanate.

This invention is illustrated by the following examples, in which the percentage in brackets after the name of functional group indicates the fraction of total oligomer functional groups ƒ that are terminated in that functional group.

### EXAMPLE 1a

One stage synthesis of an epoxy(90%)- and oleyl(10%)-functional PRUO with a polybutadiene backbone, by reacting isophorone diisocyanate (IPDI) with a hydroxy-terminated polybutadiene resin (backbone carrier), glycidol (first functional group carrier) and oleyl alcohol (second functional group carrier) in a such molar ratio that one mol of backbone carrier is mixed with two mols of IPDI, 0.9 mols of glycidol and 0.1 mols of oleyl alcohol.

100 g of hydroxy-terminated polybutadiene resin (Poly BD™ 45-HTLO, Elf Atochem North America) with hydroxy value 0.8 mg-eq/g, 5.75 g of glycidol (Dixie Chemical), 3.11 g of oleyl alcohol (Witcohol™ 90 NF, Witco Corp., hydroxy equivalent weight 210) and 20.4 g of isophorone diisocyanate (Luxate® IM, Arco Chemicals) were placed in a 3-neck flask with a heating mantle, stirrer and thermometer. The reaction mixture was stirred for 3 hours at 60° C. The temperature of the reaction mixture was lowered to 40° C., and 0.05 g of tin (II) 2-ethylhexanoate (Johnson Mathey Co.) was added. The temperature was raised to 50° C., and the reaction mixture was stirred at this temperature for 5 hours. Analysis of the resulting oligomer showed the presence of 0.01% residual isocyanate and an epoxy equivalent weight of 1700.

### EXAMPLE 1b

One stage synthesis of an epoxy(90%)- and nitrile(10%)-functional PRUO with a polyolefin backbone by reacting isophorone diisocyanate (IPDI) with a hydrogenated castor oil (backbone carrier), glycidol (first functional group carrier) and ethylene cyanohydrin (second functional group carrier) in a such molar ratio that one mol of backbone carrier is mixed with two mols of IPDI, 0.9 mols of glycidol and 0.1 mols of ethylene cyanohydrin.

400 g of hydrogenated castor oil (Nagarjuna Agro Tech Ltd., hydroxy value 161.84), 257.8 g of isophorone diisocyanate, 72.71 g of glycidol and 12.32 g of ethylene cyanohydrin (Morton International, Inc.) were placed in a chemical reaction vessel with a stirrer, heating mantle and thermometer. The mixture was stirred for three hours at 85° C. 0.5 g of tin(II) 2-ethylhexanoate was added, and the temperature was maintained at 85° C. for 5 hours. The product was analyzed and found substantially isocyanate-free. The epoxy equivalent weight was 700.

### EXAMPLE 1c

One stage synthesis of an epoxy(10%)- and nitrile(90%)-functional PRUO with a polyolefin backbone by reacting isophorone diisocyanate (IPDI) with a hydrogenated castor oil (backbone carrier), glycidol (first functional group carrier) and ethylene cyanohydrin (second functional group carrier) in a such molar ratio that one mol of backbone carrier is mixed with two mols of IPDI, 0.1 mols of glycidol and 0.9 mols of ethylene cyanohydrin.

400 g of hydrogenated castor oil, 257.8 g of isophorone diisocyanate, 12.83 g of glycidol and 69.56 g of ethylene cyanohydrin were placed in a chemical reaction vessel with a stirrer, heating mantle and thermometer. The mixture was stirred for three hours at 85° C. for 3 hours. 0.5 g of tin(II) 2-ethylhexanoate was added, and the temperature was maintained at 85° C. for 5 hours. The product was analyzed and found substantially isocyanate-free. The epoxy equivalent weight was 6400.

### EXAMPLE 1d

One stage synthesis of an methacrylic(92.1%)-, photoinitiator(6.4%)-, and isocyanate (1.5%)-functional PRUO with a polytetramethylene glycol backbone by reacting isophorone diisocyanate (IPDI) with a polytetramethylene glycol (backbone carrier), hydroxyethyl methacrylate (first functional group carrier) and photoinitiator (second functional group carrier) in a such molar ratio that one mol of backbone carrier is mixed with two mols of IPDI, 0.921 mols of hydroxyethyl methacrylate, and 0.064 mols of photoinitiator.

300 g of polytetramethylene ether glycol (QO® Polymeg® 1000 Polyol, QO Chemicals, Inc.) with hydroxyl number 112.6, 146.67 g of isophorone diisocyanate, 81 g of hydroxyethyl methacrylate (HEMA, commercial grade, Bimax Inc.) and 8.1 g of photoinitiator—a mixture of oligo-[2-hydroxy-2-methyl-1-[4-(1-methylvinyl)phenyl] propanone], 70% by weight and 2-hydroxy-2-methyl-1-phenyl-1-propanone, 30% by weight (ESACURE™ KIP-100F, Sartomer Co.) were placed in a jacketed reactor with a stirrer and thermometer. The mixture was stirred for three hours at 80° C. The temperature of the reaction mixture was dropped to 40° C., and 0.3 g of tin(II) 2-ethylhexanoate was added. The temperature was raised to 60° C., and the reaction mixture was stirred at this temperature for 4 hours. The analysis showed 1.5% residual isocyanate, left intentionally in the oligomer by the quantities of reactants used.

### EXAMPLE 1e

One stage synthesis of an methacrylic(82.2%)-, photoinitiator(6.4%), epoxy(9.9%) and isocyanate (1.5%)-functional PRUO with a polytetramethylene glycol backbone by reacting isophorone diisocyanate (IPDI) with a polytetramethylene glycol (backbone carrier), hydroxyethyl methacrylate (first functional group carrier), glycidol (second functional group carrier) and photoinitiator (third functional group carrier) in a such molar ratio that one mol of backbone carrier is mixed with two mols of IPDI, 0.822 mols of hydroxyethyl methacrylate, 0.99 mols of glycidol and 0.064 mols of photoinitiator.

300 g of polytetramethylene ether glycol (QO® Polymeg® 1000 Polyol, QO Chemicals, Inc., with hydroxyl number 112.6), 146.67 g of isophorone diisocyanate, 72.9 g of hydroxyethyl methacrylate, 4.9 g of glycidol and 8.1 g of photoinitiator (ESACURE™ KIP-100F, Sartomer Co.) were placed in a jacketed reactor with a stirrer and thermometer. The mixture was stirred for three hours at 80° C. The temperature of the reaction mixture was dropped to 40° C., and 0.3 g of tin (II)2-ethylhexanoate was added. The temperature was raised to 60° C., and the reaction mixture was stirred at this temperature for 4 hours. Analysis showed 1.5% of residual isocyanate, left intentionally in the oligomer. The adhesion of the produced material to the silicon substrate was 80% greater than for the similar material described in Example 1d.

### EXAMPLE 1f

One stage synthesis of an epoxy(90%)- and oleyl(10%)-functional PRUO with a polyolefin backbone, where isophorone diisocyanate (IPDI) is reacted with castor oil (backbone carrier), glycidol (first functional group carrier) and oleyl alcohol (second functional group carrier) in a such molar ratio that one mol of backbone carrier is mixed with two mols of IPDI, 0.9 mols of glycidol and 0.1 mols of oleyl alcohol.

510 g of castor oil (Degen Oil & Chemical Co, urethane grade, hydroxy equivalent weight 399), 100.25 g of glycidol, 31 g of oleyl alcohol and 332.5 g of isophorone diisocyanate were placed in a jacketed reaction vessel with a stirrer and thermometer. The reaction mixture was stirred for 3 hours at 70° C. The temperature of the reaction mixture was dropped to 40° C., and 0.3 g of tin(II) 2-ethylhexanoate was added. The temperature was raised to 60° C., and the reaction mixture was stirred at this temperature for 4 hours. The product was analyzed and found substantially isocyanate-free, and the epoxy equivalent weight was 650.

The produced PRUO was stable at room temperature (no increase of viscosity was observed after 3 months of storage), but it cured completely after 2 hours at 180° C. with hardness 70 Shore D.

30 g of the produced PRUO was mixed with 4.5 g of MDI-based polyisocyanate (Mondur® MRS-4, Bayer Corp.). The resulting system was stable for 3 months in a sealed container at 5° C., showed excellent adhesion to silicon, glass, metals and other substrates and was completely cured after 20 minutes at 180° C.

### Synthesis of the PRUOs in Two Stages

There are three methods to produce PRUOs in two stages. One uses a monoisocyanate-functional reactive intermediate (MIFRI), the second uses functional group-terminated compounds containing the uretidine dione structure (described in co-pending U.S. patent application Ser. No. 09/277,802) and the third utilizes isocyanate-terminated prepolymers.

(1) Two-Stage Synthesis of PRUOs through a Monoisocyanate-functional Reactive Intermediate (MIFRI)

This method requires the production of the monoisocyanate-functional reactive intermediate (MIFRI) as the first stage of the process.

In order to produce a MIFRI, a diisocyanate having isocyanate groups of unequal reactivity, such as isophorone diisocyanate (IPDI), 2,4-toluylene diisocyanate (2,4-TDI), or trimethylhexamethylene diisocyanate is mixed in 1:1 molar ratio with a FG carrier. As the isocyanate group in the para-position is much more active than the isocyanate group in the meta-position, the chance of formation of a product with two same functional groups is essentially eliminated.

The second stage of the process is to react a mixture of two or more of the synthesized MIFRIs with the backbone carrier, producing a desired PRUO.

### EXAMPLE 2a

Two stage synthesis of an epoxy(33.3%)- and tri(ethoxy)silane (66.7%)-functional PRUO with a poly(oxypropylene) backbone.

(i) Production of tri(alkoxy)silane-terminated MIFRI. 300 g of N-phenyl-3-aminopropyl-tri(ethoxy)silane (Silquest Y-9669, made by CK Witco Corp) and 228 g of isophorone diisocyanate (1:1 molar ratio) were placed in a jacketed reaction vessel with a stirrer and thermometer. After the reaction mixture was stirred for 1 hour at 70° C., 0.3 g of tin(II) 2-ethylhexanoate was added. After one more hour isocyanate contents of the produced resin was analyzed by titration. 50% reduction of the normal concentration of isocyanate groups was observed. The produced bifunctional substituted urea adduct had isocyanate group and tri(ethoxy)silane group.

(ii) Production of epoxy-terminated MIFRI. 100 g of glycidol and 300 g of isophorone diisocyanate (1:1 molar ratio) were placed in a jacketed reaction vessel with a stirrer and thermometer. After the reaction mixture was stirred for 1 hour at 70° C., and 0.3 g of tin(II) 2-ethylhexanoate was added. After one more hour isocyanate contents of the produced resin was analyzed by titration. 50% reduction of the normal concentration of isocyanate groups was observed. The produced bifunctional adduct had isocyanate group and epoxy group.

(iii) Production of epoxy/tri(alkoxy)silane-functional PRUO. 89.1 g of epoxy-terminated MIFRI (1 molar part), 155.4 g of tri(ethoxy)silane-terminated MIFRI (2 molar parts) and 300 g of poly(oxypropylene) triol (Jeffol T-1000, produced by Huntsman Corp., hydroxy equivalent weight 334) (1 molar part) were placed in a jacketed reaction vessel with a stirrer and thermometer. After the reaction mixture was stirred for 3 hours at 70° C., 0.3 g of tin(II) 2-ethylhexanoate was added. The reduction of isocyanate groups was monitored using IR spectrophotometer. The reaction was concluded when the isocyanate band could be no longer detected. The produced oligomer had on the average two tri(ethoxy)silane terminal group and one epoxy terminal group.

### EXAMPLE 2b

Two stage synthesis of a mercaptan(90%)- and tertiary amine(10%)-functional PRUO with a poly(oxypropylene) backbone.

(i) Production of a mixture of mercaptan- and tertiary amine-functional MIFRIs. 69.3 g (9 molar parts) of mercaptoethanol (made by Morton Corp), 10 g (1 molar part) of N,N′dimethylethanolamine (reagent grade) and 250 g (10 molar parts) of isophorone diisocyanate were placed in a jacketed reaction vessel with a stirrer and thermometer. The reaction mixture was stirred for 4 hours at 50° C. The isocyanate contents of the produced resin was analyzed by titration. 50% reduction of the normal concentration of isocyanate groups was observed.

(ii) Production of mercaptan/tertiary amine-functional PRUO. 374 g (10 molar parts) of poly(oxypropylene) triol (Jeffol T-1000, produced by Huntsman Corp., hydroxy equivalent weight 334) were added to the reactor containing the products from stage (i). After reaction mixture was stirred for 4 hours at 60° C., 0.3 g of tin(II) 2-ethylhexanoate was added. The reduction of isocyanate groups was monitored using an IR spectrophotometer. The reaction was concluded when the isocyanate band could be no longer detected. The produced oligomer was 90% mercaptan-functional and 10% tertiary amine-functional.

(2) Two-stage Synthesis of PRUOs through Functional Group-terminated Compounds Containing the Uretidine Dione Structure

At the first stage of the synthesis, a diisocyanate dimer (a diisocyanate-terminated compound that contains a thermally unstable uretidine dione structure, which, under the influence of elevated temperature decomposes to release two diisocyanate molecules; many such diisocyanate dimers are commercially available) is reacted with two or more FG carriers at a temperature below that at which the uretidine dione structure decomposes (for example, not exceeding 50° C.), thereby forming a mixture of functional group-terminated compounds containing the uretidine dione structure. The resulting compounds react with the backbone carrier at an elevated temperature (i.e. at a temperature above that at which the uretidine dione structure decomposes) through the combination of isocyanate groups released by the break-up of the uretidine dione structure and the isocyanate-reactive terminal groups of the backbone carrier.

(3) Two-stage Synthesis of PRUOs through an Isocyanate-terminated Prepolymer

The first stage of the synthesis is production of an isocyanate-terminated prepolymer. This first stage of synthesis is well-described in the literature, and in addition, commercial prepolymers are widely available. At each end, such a polymer has an isocyanate group attached to the backbone polymer via a urethane or urea linkage. At the second stage, the synthesized or commercially obtained prepolymer is reacted simultaneously with two or more of the FG carriers, producing a PRUO with the desired properties.

### EXAMPLE 2c

Two stage synthesis of an epoxy(85%), oleyl(10%) and isocyanate(5%)-functional PRUO with a polytetramethylene glycol backbone.

493 g of TDI-terminated polytetramethylene-glycol prepolymer (Andur® 2-90AP, Anderson Development Co., with 4.15% of isocyanate groups), 34.1 g of glycidol, 10.3 g of oleyl alcohol and 0.3 g of tin (II) 2-ethylhexanoate were placed in a 3-neck flask with a heating mantle, stirrer and thermometer. The reaction mixture was stirred for 3 hours at 80° C. The oligomeric product was analyzed and found to contain 5% of the residual isocyanate groups.

### EXAMPLE 2d

Two stage synthesis of an epoxy(90%)- and oleyl(10%)-functional PRUO with a polytetramethylene glycol backbone.

502 g of TDI-terminated polytetramethylene-glycol prepolymer (Andur® 2-90AP, Anderson Development Co., with 4.15% of isocyanate groups), 36.5 g of glycidol, 11 g of oleyl alcohol and 0.3 g of tin (II) 2-ethylhexanoate were placed in a 3-neck flask with a heating mantle, stirrer and thermometer. The reaction mixture was stirred for 3 hours at 80° C. The oligomer product was analyzed and found substantially isocyanate-free. The epoxy equivalent weight was 900.

The viscosity of the produced resin was three times less than that of a model system (comparative oligomer synthesized under the same conditions without the oleyl alcohol). A chemical resistance test of the product cured with methyltetrahydrophthalic anhydride (AC-220E, Lonza Corp.) showed 5 times less weight gain in limonene (BioAct® EC-7R, Petroferm, Inc.)

### EXAMPLE 2e

Two stage synthesis of an acrylic(93.5%)-functional PRUO with photoinitiator(6.5%) and a polytetramethylene glycol backbone.

1220 g of TDI-terminated polytetramethylene-glycol prepolymer (Airthane PET-95A, Air Products, Inc., 6.7% of isocyanate groups), 226 g of hydroxyethyl methacrylate, 25.5 of photoinitiator (ESACURE® KIP 100F, Sartomer Co.) and 0.45 g of tin(II) 2-ethylhexanoate were placed in a 3-neck flask with a heating mantle, stirrer and thermometer. The reaction mixture was stirred for 4 hours at 70° C. The product was analyzed and found substantially isocyanate-free.

Curing (polymerization) of a resin produced from this oligomer was achieved in 40% of the time taken for curing a model oligomer (synthesized under the same conditions without the photoinitiator) to which the same photoinitiator was added in the equivalent amount prior to curing.

### EXAMPLE 2f

Two stage synthesis of an epoxy(50%)-, siloxy(40%)- and oleyl(10%)-functional PRUO with a polyolefin backbone.

500 g of castor oil, 54.6 g of glycidol, 30.5 g of oleyl alcohol and 324.5 g of isophorone diisocyanate were placed in a dried jacketed reaction vessel with a stirrer, thermometer and nitrogen flow. The reaction mixture was stirred for 3 hours at 70° C. The temperature of the reaction mixture was dropped to 40° C., and 0.3 g of tin(II) 2-ethylhexanoate was added. The temperature was raised to 60° C., and the reaction mixture was stirred at this temperature for 4 hours. The analysis showed 80% conversion of isocyanate groups. 175 g of N-phenyl-3-aminopropyl-tri(ethoxy)silane (Silquest Y-9669, made by CK Witco Corp) was added dropwise to the reaction mixture. After another 30 minutes of mixing the product was analyzed and found substantially isocyanate-free.

The herein-described and claimed products and methods of their synthesis substantially widen the range of urethane- and urea-functional oligomers, expand their properties, provide mechanisms for the adjustment of these properties, and ease the production of oligomers.

Although the present invention and its advantages have been described in detail, it should be understood that the present invention is not limited to or defined by what is shown or discussed herein; rather, the invention may be practiced with the specific details herein omitted or altered. The drawings, description and discussion herein illustrate technologies related to the invention, show examples of the invention and provide examples of using the invention. Known methods, procedures, systems, circuits or components may be discussed or illustrated without giving details, so to avoid obscuring the principles of the invention. One skilled in the art will realize that changes, substitutions, and alternations could be made in numerous implementations, modifications, variations, selections among alternatives, changes in form, and improvements without departing from the principles, spirit or legal scope of the invention. Accordingly, the scope of the present invention should be determined by the following claims and their legal equivalents.

What is claimed is:

1. An oligomer of formula B (A)ₙ where
B is a backbone,
A is a formula —R₁—C(O)—NH—R₂—R₃, and
n is an integer of at least 2, said integer defining the number of said A's bonded to said B, wherein
said B is selected from the group consisting of polyesters, polyethers, polyolefins, polybutadienes, polycarbonates, polysiloxanes, carbohydrates, polyacrylates, polysulfide sand mixtures and copolymers thereof;
each R₁, which may be same or different between said A's, is selected from the group consisting of —O—, —S—, 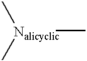
where the nitrogen atom N_{alicyclic} is heterocyclic, or —N(R₃)— where R₅ is selected from the group consisting of hydrogen and a monovalent organic radical;
C(O) is a carbonyl;
each R₂, which may be same or different between said A's, is a bivalent organic radical; and
each R₃ is an isocyanate group of formula —N═C═O or a group of formula —NH—C(O)—R₁′—R₄—ƒ, wherein
at least two different R₃ groups are always present in said oligomer and if one of said R₃ groups is isocyanate, then at least three different R₃ groups are present in said oligomer;
each R₁′, which may be same or different from R₁ within each of said A's, is defined the same as R₁;
each R₄ is a radical selected from the group consisting of bivalent aliphatic, bivalent cycloaliphatic, bivalent aromatic, bivalent substituted aliphatic, bivalent substituted cycloaliphatic, bivalent substituted aromatic radicals, bifunctional polyesters, bifunctional polyethers, bifunctional polyolefins, bifunctional polybutadienes, bifunctional polysiloxanes, and bifunctional polyacrylates; and
each functional group ƒ is independently selected from a reactive functional group category, a catalytic and stabilizer functional group category, or a physical property-modifying functional group category, wherein
ƒ is not a photoinitiator;
if any one of said selected functional group ƒ is an alkoxysilane, then no other functional group ƒ in said oligomer is an alkyl group; and
if, for a particular A, R₁′ is selected as —N(R₅)— and ƒ is selected as alkoxysilane, then no other R₃ in said oligomer is —NH—C(O)—OCH₂(CH₂)₁₆CH₃.

2. The oligomer of claim 1, wherein n is 2, 10, or any integer therebetween.

3. The oligomer of claim 2, wherein said reactive functional group category, said catalytic and stabilizer functional group category, and said physical property-modifying functional group category contain functional groups ƒ of epoxys, acrylates, methacrylates, mercaptans, vinyloxys, allyls, carboxyls, ketones, nitriles, organic nitrates, primary, secondary and tertiary amines, organic peroxides, alkoxysilanes, carbonates, heterocyclics, imidazoles, organic peroxides, metalloorganics, hydroxyketones, hydroquinones, aliphatics, cycloaliphatics, aromatics, saturated and unsaturated organics, and halogenated organics.

4. The oligomer of claim 2, wherein 0.1 to 10% of all R₃ groups in said oligomer contain tertiary amine functional groups ƒ, and the remainder of R₃ groups in said oligomer contain epoxy functional groups ƒ, and also isocyanate R₃ groups.

5. The oligomer of claim 2, wherein 0.1% to 20% of all functional groups ƒ in said oligomer are selected from said catalytic and stabilizer functional group category.

6. The oligomer of claim 2, wherein at least a portion of all functional groups ƒ in said oligomer are epoxy groups.

7. A method of synthesis of the oligomer of claim 2 in a single stage, comprising the reaction of a backbone carrier, a diisocyanate having two isocyanate groups of unequal reactivity, and at least two different functional group (FG) carriers.

8. The method of synthesis of claim 7, where the sum of —R₁H equivalents of backbone carrier equals approximately one-half the total amount of isocyanate equivalents of the diisocyanate, and the sum of the —R₁H equivalents of the FG carriers is no more than approximately one-half the total isocyanate functionality of the diisocyanate.

9. The method of synthesis of claim 8 wherein the synthesis takes place either in the absence of any catalyst, or in the presence only of an isocyanate reaction catalyst.

10. A method of synthesis of the oligomer of claim 2 in two stages, comprising:
(1) preparation of at least two different monoisocyanate-functional reactive intermediates (MIFRIs) by either: (a) the reaction, for each intermediate, of a functional group (FG) carrier with a diisocyanate molecule having isocyanate groups of unequal reactivity; or, (b) the simultaneous reaction of at least two different FG carriers with a diisocyanate molecule having isocyanate groups of unequal reactivity; followed by,
(2) reaction of the at least two different MIFRIs with a backbone carrier.

11. The method of synthesis of claim 10, where the sum of —R₁′H equivalents of the FG carriers is no less than approximately one-half the total amount of isocyanate equivalents of the diisocyanate.

12. The method of synthesis of claim 10, where the sum of —R₁H equivalents of backbone carrier equals, or is slightly less, than the total isocyanate equivalents of the MIFRIs.

13. A method of synthesis of the oligomer of claim 2 in two stages, comprising:
(1) preparation of an isocyanate-terminated prepolymer by reaction of a backbone carrier with a diisocyanate having isocyanate groups of unequal reactivity; and
(2) reaction of the isocyanate-terminated prepolymer with at least two different functional group (FG) carriers.

14. The method of synthesis of claim 13, where the total R₁H equivalents of the backbone carrier equals or exceeds approximately one-half of the total isocyanate equivalents of the diisocyanate.

15. The method of synthesis of claim 13, where the sum of the R₁′H equivalents of the FG carriers equals, or is slightly less, than the total isocyanate equivalents of the isocyanate-terminated prepolymer.

16. The oligomer of claim 2 wherein at least one functional group ƒ is an epoxy formed using glycidol as functional group carrier, whereby a cured product can be created by way of the intramolecular rearrangement of the urethane-epoxy chemical structure.

17. Method of using the oligomer of claim 16 comprising the step of heating the oligomer, whereby a cured product is created by way of the intramolecular rearrangement of the urethane-epoxy chemical structure.

18. An oligomer of formula B (A)ₙ where
B is a backbone,
A is a formula —R₁—C(O)—NH—R₂—R₃, and
n is an integer of at least 2, said integer defining the number of said A's bonded to said B, wherein
said B is selected from the group consisting of polyesters, polyethers, polyolefins, polybutadienes, polycarbonates, polysiloxanes, carbohydrates, polyacrylates, polysulfide sand mixtures and copolymers thereof;
each R₁, which may be same or different between said A's, is selected from the group consisting of —O—, —S—, 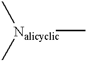
where the nitrogen atom N_{alicyclic} is heterocyclic, or —N(R₅) where R₅ is selected from the group consisting of hydrogen and a monovalent organic radical;
C(O) is a carbonyl;
each R₂, which may be same or different between said A's, is a bivalent organic radical; and
each R₃ is an isocyanate group of formula —N═C═O or a group of formula —NH—C(O)—R₁′—R₄—ƒ, wherein
at least two different R₃ groups are always present in said oligomer and if one of said R₃ groups is isocyanate, then at
least three different R₃ groups are present in said oligomer;
each R₁′, which may be same or different from R₁ within each of said A's, is defined the same as R₁;
each R₄ is a radical selected from the group consisting of bivalent aliphatic, bivalent cycloaliphatic, bivalent aromatic, bivalent substituted aliphatic, bivalent substituted cycloaliphatic, bivalent substituted aromatic radicals, bifunctional polyesters, bifunctional polyethers, bifunctional polyolefins, bifunctional polybutadienes, bifunctional polysiloxanes, and bifunctional polyacrylates; and
each functional group ƒ is independently selected from a reactive functional group category, a catalytic and stabilizer functional group category, or a physical property-modifying functional group category, wherein
at least one ƒ is an organic peroxide;
if any one of said selected functional group ƒ is an alkoxysilane, then no other functional group ƒ in said oligomer is an alkyl group; and
if, for a particular A, R₁′ is selected as —N(R₅)— and ƒ is selected as alkoxysilane, then no other R₃ in said oligomer is —NH—C(O)OCH₂(CH₂)₁₆CH₃.
